(19) United States
(12) Patent Application Publication
(10) Pub. No.: US 2015/0229596 A1
(43) Pub. Date: Aug. 13, 2015

(54) EMAIL THREADING METHOD AND ELECTRONIC DEVICE THEREFOR

(71) Applicant: Samsung Electronics Co., Ltd., Suwon-si (KR)

(72) Inventors: Jihyun KIM, Suwon-si (KR); Geonsoo KIM, Suwon-si (KR)

(21) Appl. No.: 14/606,353

(22) Filed: Jan. 27, 2015

(30) Foreign Application Priority Data
Feb. 7, 2014 (KR) 10-2014-0014132

(51) Int. Cl. H04L 12/58; G06F 3/0488; G06F 3/0484

(52) U.S. Cl. CPC H04L 51/16; G06F 3/04842; G06F 3/0488; H04L 51/24

(57) ABSTRACT

An email threading method and an electronic device are provided. The email threading method includes executing an email application, receiving a first email based on the email application, determining arrival of a second email pertaining to the first email at an email server, displaying, when a request is detected, the second email, threading the second email and an email being composed, and transmitting the threaded email to a mail server.

### CROSS-REFERENCE TO RELATED APPLICATION(S)

This application claims the benefit under 35 U.S.C. §119(a) of a Korean patent application filed on Feb. 7, 2014 in the Korean Intellectual Property Office and assigned Serial number 10-2014-0014132, the entire disclosure of which is hereby incorporated by reference.

### TECHNICAL FIELD

The present disclosure relates to an electronic device. More particularly, the present disclosure relates to an electronic mail (email) threading method and an electronic device therefor.

### BACKGROUND

With the advancement of mobile communication technology, electronic devices are now capable of taking still and motion pictures and playing multimedia files, such as audio and video files. The electronic devices are implemented in the form of multimedia players capable of performing various multimedia functions, such as a game function, a broadcast receiver/player function, a navigation service function, and the like.

The electronic devices are capable receiving various types of inputs made in various input methods with various input units and managing data communications through various communication protocols. For example, the electronic devices equipped with communication applications, such as email client and messenger, can be used as communication tools for people in everyday life and business. Such communication applications, such as email client and messenger increases daily communication traffic.

According to the related art, s emails are transmitted/received, and several emails generate new threads in the form of reply or forward message simultaneously.

Since the emails exchanged among several people generate respective threads, opening the emails one by one is necessary to determine the replies and to store all the emails in order to record the history of the email, resulting in user inconvenience and storage space waste.

Therefore, a need exists for an email threading method and an electronic device therefor.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an electronic device for facilitating combination of email threads.

In accordance with an aspect of the present disclosure, an email threading method of an electronic device is provided. The email threading method includes executing an email application, receiving a first email based on the email application, determining arrival of a second email pertaining to the first email at an email server, displaying, when a request is detected, the second email, threading the second email and an email being composed, and transmitting the threaded email to a mail server.

In accordance with another aspect of the present disclosure, an electronic device is provided. The electronic device includes a display unit having a display module configured to display an email composition window and a list, an input unit having at least one of a touch panel, a pen sensor, and a microphone that are capable of recognizing composition of an email, a memory configured to store an email application providing the email composition window, and a processor configured to control a communication unit configured to communicate between the electronic device and an email server, wherein the processor is further configured to execute the email application, to receive a first email based on the email application, to determine arrival of a second email pertaining to the first email at an email server, to display, when a request is detected, the second email, to thread the second email and an email being composed, and to transmit the threaded email to the mail server.

In accordance with another aspect of the present disclosure, a non-transitory computer readable storage medium for storing an email threading program is provided. The email threading program includes executing an email application, receiving a first email based on the email application, determining arrival of a second email pertaining to the first email at an email server, displaying, when a request is detected, the second email, threading the second email and an email being composed, and transmitting the threaded email to a mail server.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an email thread combining system according to an embodiment of the present disclosure;

FIG. 2 is a block diagram illustrating a configuration of an electronic device according to an embodiment of the present disclosure;

FIG. 3 is a diagram illustrating an email thread combining procedure according to an embodiment of the present disclosure;

FIG. 4 is a signal flow diagram illustrating an information and memo display procedure according to an embodiment of the present disclosure;

FIGS. 5A, 5B, and 5C are diagrams illustrating screen displays of an email threading procedure according to an embodiment of the present disclosure;

FIGS. 6A, 6B, 6C, and 6D are diagrams illustrating screen displays of an email threading procedure according to an embodiment of the present disclosure; and

FIGS. 7A and 7B are diagrams illustrating screen displays of an email treading procedure according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The electronic device according to the various embodiments of the present disclosure may be a device including a heart rate measuring function. For example, the electronic device corresponds to a combination of at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player (e.g., a Motion Pictures Expert Group (MPEG-1 or MPEG-2) Audio Layer 3 (MP3) player), a mobile medical device, a camera, or a wearable device. Examples of the wearable device are a head-mounted-device (HMD) (e.g., electronic eyeglasses), electronic clothing, an electronic bracelet, an electronic necklace, an appcessory, an electronic tattoo, a smart watch, and the like.

The electronic device according to the various embodiments of the present disclosure may be smart home appliances with a heart rate measuring function. Examples of the smart home appliances are a television (TV), a Digital Video Disk (DVD) player, an audio system, a refrigerator, an air-conditioner, a cleaning device, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, an electronic album, or the like.

The electronic device according to the various embodiments of the present disclosure may include at least one of the following: medical devices (e.g., Magnetic Resonance Angiography (MRA), Magnetic Resonance Imaging (MRI), Computed Tomography (CT), a scanning machine, an ultrasonic scanning device, and the like), a navigation device, a Global Positioning System (GPS) receiver, an Event Data Recorder (EDR), a Flight Data Recorder (FDR), a vehicle infotainment device, an electronic equipment for ships (e.g., navigation equipment, a gyrocompass, and the like), avionics, a security device, a head unit for vehicles, an industrial or home robot, an automatic teller's machine (ATM), a point of sales (POS) system, and the like.

The electronic device according to the various embodiments of the present disclosure may include at least one of the following: furniture or a portion of a building/structure, an electronic board, an electronic signature receiving device, a projector, various measuring instruments (e.g., a water meter, an electric meter, a gas meter and a wave meter), and the like, which are equipped with a heart rate measuring function, respectively. The electronic device according to the various embodiments of the present disclosure may also include a combination of the devices listed above. In addition, the electronic device according to the various embodiments of the present disclosure may be a flexible device. It is obvious to those skilled in the art that the electronic device according to the various embodiments of the present disclosure is not limited to the aforementioned devices.

Hereinafter, electronic devices according the various embodiments of the present disclosure are described with reference to the accompanying drawings. In the description, the term a ‘user’ may be referred to as a person or a device that uses an electronic device, e.g., an artificial intelligent electronic device.

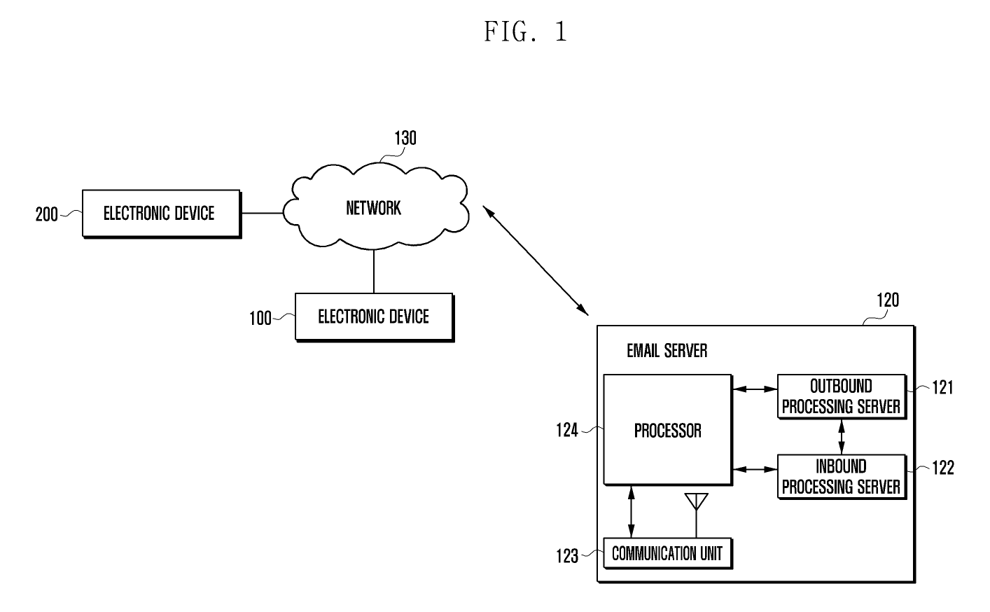

FIG. 1 is a diagram illustrating an email thread combining system according to an embodiment of the present disclosure.

Referring to FIG. 1, an email thread combining system includes an email server 120 and electronic devices 100 and 200.

The email server 120 includes an outbound processing server 121 for processing outbound mails. For example, the outbound processing server 121 may include a Simple Email Transfer Protocol (SMTP) server. The email server 120 also includes an inbound processing server 122 for processing inbound mails. For example, the inbound processing server may include at least one of a Post Office Protocol (POP) server and an Internet Messaging Access Protocol (IMAP) server. The email server 120 also includes a communication unit 123 and a processor 124. The outbound processing server 121 operates using a standard protocol for transmitting the email over Internet. The outbound processing server 121 may transmits emails through the outbound protocol. The outbound processing server 121 may arrange the emails in exchanging emails between the electronic devices 100 and 200 over a network 130. The inbound processing server 122 (e.g., a POP server, an IMAP server, and the like) may store the emails generated over the network 130 between the electronic devices 100 and 200. The processor of the electronic device 200 may receive the email stored in the inbound processing server 122.

The communication unit 123 may establish a connection between the email server 120 and the electronic device 200. The email server 120 is connected with a Local Area Network (LAN) and communicates with the electronic device 200 through radio communication channel. Wireless communication may include at least one of the following: Wireless Fidelity (Wi-Fi), Bluetooth (BT), near field communication (NFC), GPS or cellular communication (e.g., Long Term Evolution (LTE), Long Term Evolution-Advanced (LTE-A), Code Division Multiple Access (CDMA), Wideband Code Division Multiple Access (WCDMA), Universal Mobile Telecommunications System (UMTS), Wireless Broadband (Wi-Bro), Global System for Mobile Communications (GSM), and the like). Wired communication may include at least one of the following: universal serial bus (USB), high definition multimedia interface (HDMI), recommended standard 232 (RS-232), plain old telephone service (POTS), and the like.

The processor 124 receives commands from other components (i.e., the outbound processing server 121, the inbound processing server 122, and the communication unit 123), interprets the commands, and executes operation or processes data according to the interpreted commands.

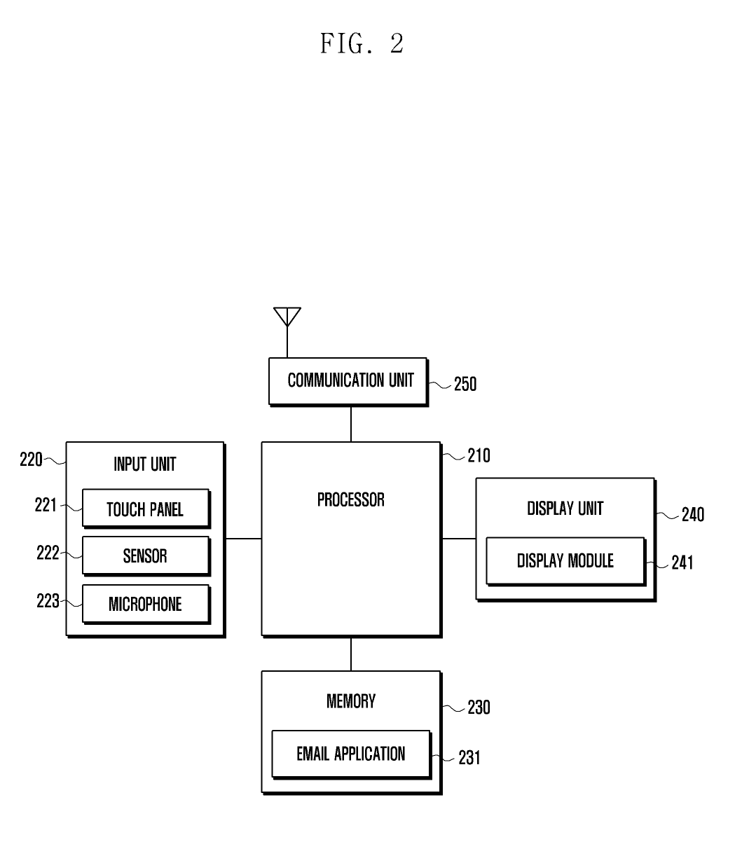

FIG. 2 is a block diagram illustrating a configuration of an electronic device according to an embodiment of the present disclosure.

Referring to FIG. 2, the electronic device 200 includes a processor 210, an input unit 220, a memory 230, a display unit 240, and a communication unit 250. The processor 210 receives signals from other components (i.e., the input unit 220, memory 230, display unit 240, and communication unit 250), interprets the signals, and performs operations or processing data according to the interpretation result.

The input unit 220 includes a touch panel 221, a sensor 222, and a microphone 223. The touch panel 221 may be implemented in one of a capacitive type, a resistive type, an infrared type, and a microwave type to detect a touch input. The touch panel 221 may include a controller (not shown). In the capacitive type touch panel, it is also possible to detect an indirect touch as well as a direct touch. The direct touch may denote the contact made by a conductive material (e.g., a finger, a stylus pen, and the like) on a touchscreen. According to an embodiment of the present disclosure, the indirect touch may denote the contact or approach made by the conductive material covered with non-conductive material (e.g., a finger in a glove) on to the touchscreen. According to another embodiment of the present disclosure, the indirect touch may denote the contact made by a finger on the touchscreen covered by non-conductive material. According to another embodiment of the present disclosure, the indirect touch may denote a finger gesture made above the touchscreen in a certain distance range without contact, i.e., a hovering gesture. The touch panel 221 includes a tactile layer. In this case, the touch panel 221 may provide tactile feedback to the user. The touch panel 221 may be installed on the screen (i.e., a touchscreen) of a display module 241. For example, the touch panel 221 may be implemented in one of add-on type which is located on the screen of the display unit or an on-cell type or an in-cell type which is inserted into the display unit.

The sensor 222 may include a gesture sensor, a gyro sensor, a barometric sensor, a magnetic sensor, an acceleration sensor, a grip sensor, a proximity sensor, a red, green, blue (RGB) sensor, a biosensor, a temperature and humidity sensor, and a face recognition sensor. The sensor 222 measures the physical quantity or operation status of the electronic device 200 and generates an electric signal based on the measured or detected information. The sensor 222 may include a control circuit for controlling at least one detecting modules. The microphone 223 may receive the voice input of the user or recognize the voice signal from another electronic device to receive a text or a picture. The microphone may be a directional or non-directional microphone.

The memory 230 may store instructions or data transferred from/created in the processor 210 or the other components (e.g., the input/output interface, display, communication interface, and the like). The memory 230 may include programming modules, e.g., a kernel, middleware, an application programming interface (API), an application module, and the like. Each of the programming modules may be software, firmware, hardware or a combination thereof. The memory also may store an email application. An email application 231 provides an interface for email-related process, such as writing, transmitting, and receiving emails.

The display unit 240 includes a display module 241. The display module 241 includes a panel. The panel may be, for example, a Liquid-Crystal Display (LCD) or an Active-Matrix Organic Light-Emitting Diode (AM-OLED). The panel may be embodied to be, for example, flexible, transparent, or wearable. The panel may be configured to be an integrated module with the touch panel. The hologram shows a three-dimensional image in the air using interference of light. According to an embodiment of the present disclosure, the display module 241 may further include a control circuit for controlling the panel or the hologram.

The communication unit 250 connects communication between another electronic device and the electronic device 100. The communication unit may include a wireless communication unit. The wireless communication unit may support a short range communication protocol (for example, Wi-Fi, BT, NFC) or a network communication (for example, the Internet, a LAN, a wide area network (WAN), a telecommunication network, a cellular network, a satellite network, a POTS, and the like). The another electronic device may be a device identical to the electronic device 100, or may be a different device (for example, a different type of device).

According to various embodiments of the present disclosure, the electronic device 100 may include a display unit having a display module for displaying an email composition window and list, an input unit having a touch panel for receiving email composition input, a pen sensor, and a microphone, a memory for storing an email application of providing the email composition window, and a processor of controlling the communication unit for communication with an email server, the processor executing and controlling the email application to receive a first email, recognizing arrival of a second email at the email server, displaying the second email if necessary, threading the second email and the email being composed, and transmitting the combined email to the email server.

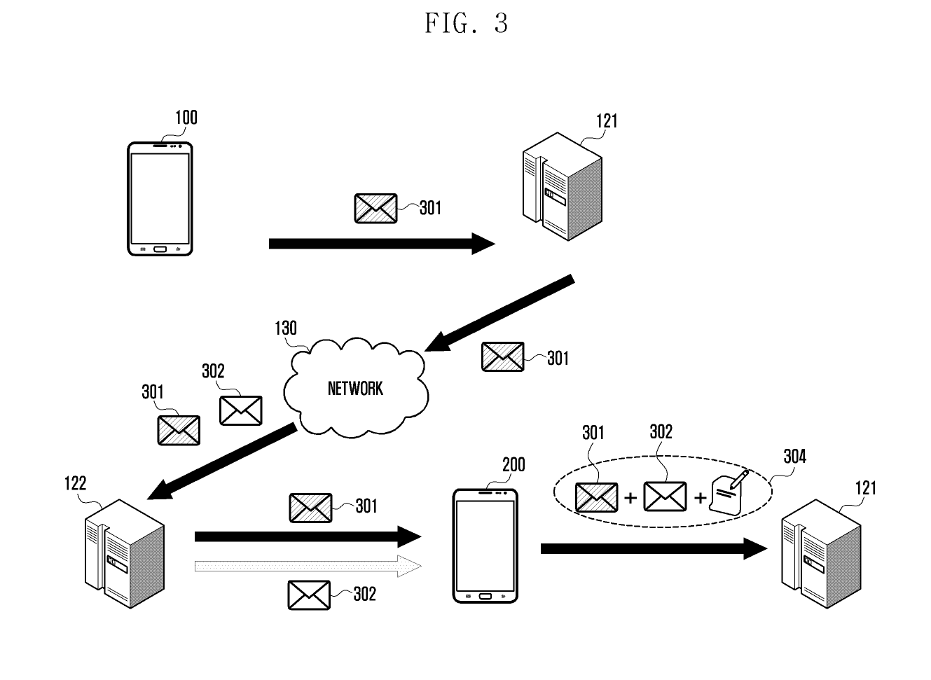

FIG. 3 is a diagram illustrating an email thread combining procedure according to an embodiment of the present disclosure.

Referring to FIG. 3, the processor 210 of the electronic device 200 controls the communication unit 250 to receive a first email 301 and a second email 302 pertaining to the first email 301 from the inbound processing server 122 (e.g., a POP server, an IMAP server, and the like) through the network 130. According to an embodiment of the present disclosure, the first email 301 may be the original email which is followed by replies or forwards and which has been sent to at least one electronic device including the electronic device 200. According to an embodiment of the present disclosure, the second email 302 may be an email (e.g., reply or forward) pertaining to the first email 301 transmitted by another electronic device through the network 130. According to an embodiment of the present disclosure, the second email 302 may threaded by the electronic device 200.

The processor 210 of the electronic device 200 may thread the first and second emails 301 and 302, respectively, and the email being composed selectively into a threaded email which is transmitted to the outbound processing server 121 through the communication unit 250.

The processor 124 of the email server 120 may control the communication unit 123 to receive the first email 301 transmitted by the second electronic device 100 in the email transfer procedure between the servers 121 and 122 on the network 130. The processor 210 of the electronic device 200 may control the communication unit 250 to receive the first and second emails 301 and 302, respectively, from the inbound processing server 122 (e.g., a POP server, an IMAP server, and the like). The processor 210 of the electronic device 200 may thread the first and second emails 301 and 302, respectively, with the reply being composed in response to the user input received through the input unit 220 selectively.

The processor 210 of the electronic device 200 may control the communication unit 250 to transmit a threaded email 304 to the outbound processing server 121 (e.g., an SMTP server). The processor 124 of the email server 120 may control to transfer the email received by the outbound processing server 121 and the email received from the electronic device 100 to the inbound processing server 122 (e.g., a POP server, an IMAP server, and the like).

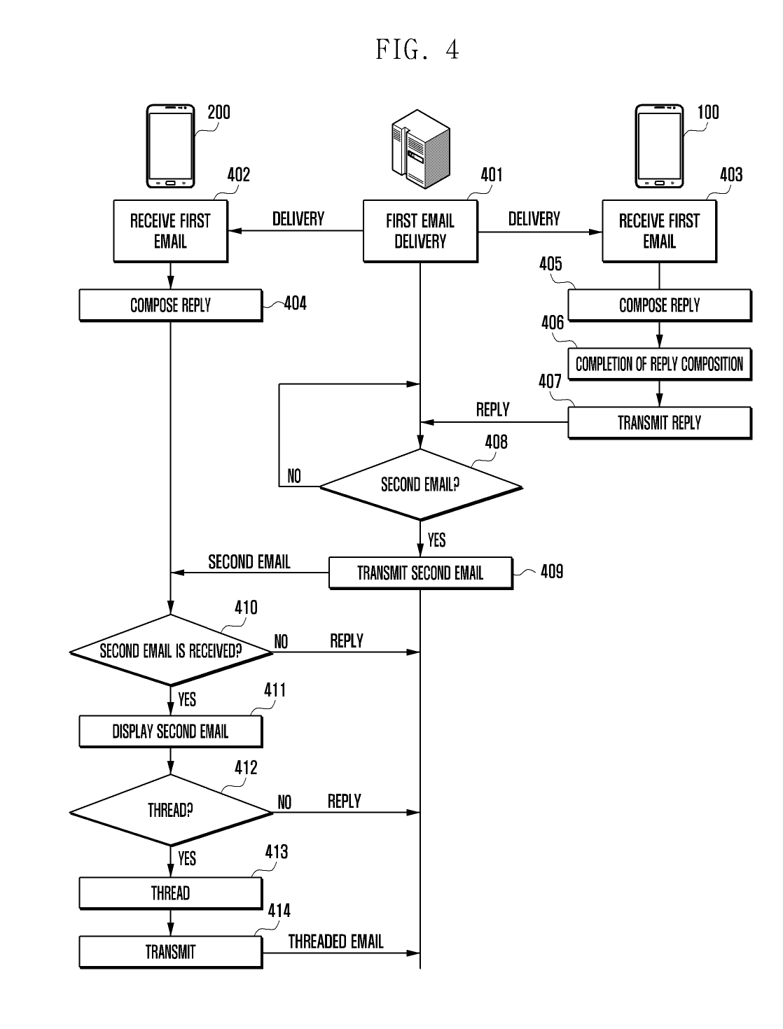

FIG. 4 is a signal flow diagram illustrating an information and memo display procedure according to an embodiment of the present disclosure.

According to an embodiment of the present disclosure, the procedure of FIG. 4 is divided roughly into three procedures: receiving, at the electronic device 200, another reply from another electronic device 100 through the email server 120 in the middle of composing a reply, threading the emails, and controlling the communication unit 250 to transmit the threaded email 304 to the email server 120. The procedure of receiving, at the electronic device 200, another reply from another electronic device 100 through the email server 120 in the middle of composing a reply is performed through operations 401 to 409.

Referring to FIG. 4, the processor 124 of the email server 120 may control the communication unit 123 to transmit the first email 301 to the electronic devices 100 and 200 at operation 401. The processor 210 of the electronic device 200 controls the communication unit 250 to receive the first email 301 from the email server 120 at operation 402. The processor (not shown) of the electronic device 100 controls the communication unit (not shown) to receive the first email 301 from the email server 120 at operation 403. The processor 210 of the electronic device 200 composes a reply by receiving the user input mad through the input unit 220 at operation 404. For example, the email 302 pertaining to the first email 301 is composed by at least one of the input modules of the input unit 220.

The processor (not shown) of the electronic device 100 may compose the email 302 pertaining to the first email 301 at operation 405. The processor of the electronic device 100 may recognize the completion of the composition of the email 302 at operation 406. The processor of the electronic device 100 controls the communication unit (not shown) to transmit the email 302 to the outbound processing server 121 (e.g., an SMTP server) through the network 130 at operation 407.

The processor 124 of the email server 120 determines whether the reply received from the electronic device 100 is the second email 302 at operation 408. The processor 124 of the email server 120 may determine whether the received email is pertaining to the first email 301. For example, the processor 124 of the email server 120 may review the title of the received email to determine whether it is pertaining to the first email 301 and, if so, determines the reply as the second email 302 pertaining to the first email.

If the second email 302 pertaining to the first email 301 is received, the processor 124 of the email server 120 controls the communication unit 123 to transmit a notification message to the electronic device 200 notifying of the arrival of the second email 302 at the email server 120 at operation 409. The threading procedure is performed through operations 410 to 413.

The processor 210 of the electronic device 200 determines whether the second email 302 transmitted by the email server 120 is received through the communication unit 250 at operation 410. If it is determined that the second email 302 is not received from the inbound processing server 122 (e.g., a POP server, an IMAP server, and the like) at operation 410, the processor 210 of the electronic device 200 controls the communication unit 250 to transmit to the outbound processing server 121 (e.g., an SMTP server) the reply which is composed independently of the second email 302.

Otherwise, if it is determined that the second email 302 is received from the inbound processing server 122 (e.g., a POP server, an IMAP server, and the like), the processor 210 of the electronic device 200 controls the display module 241 to display the notification or a list of the second email 302 at operation 411.

The processor 210 of the electronic device 200 determines whether to thread the second email 302 and the reply being composed at operation 412. If it is determined to not thread, the processor 210 of the electronic device 200 controls the communication unit 250 to transmit the composed reply to the outbound processing server 121 (e.g., an SMTP server). If it is determined to thread the second email 302 and the reply being composed at operation 412, the processor 210 of the electronic device 200 threads the second email 302 and the reply at operation 413.

The processor 210 of the electronic device 200 controls the communication unit 250 to transmit the threaded email 304 to the outbound processing server 121 at operation 414.

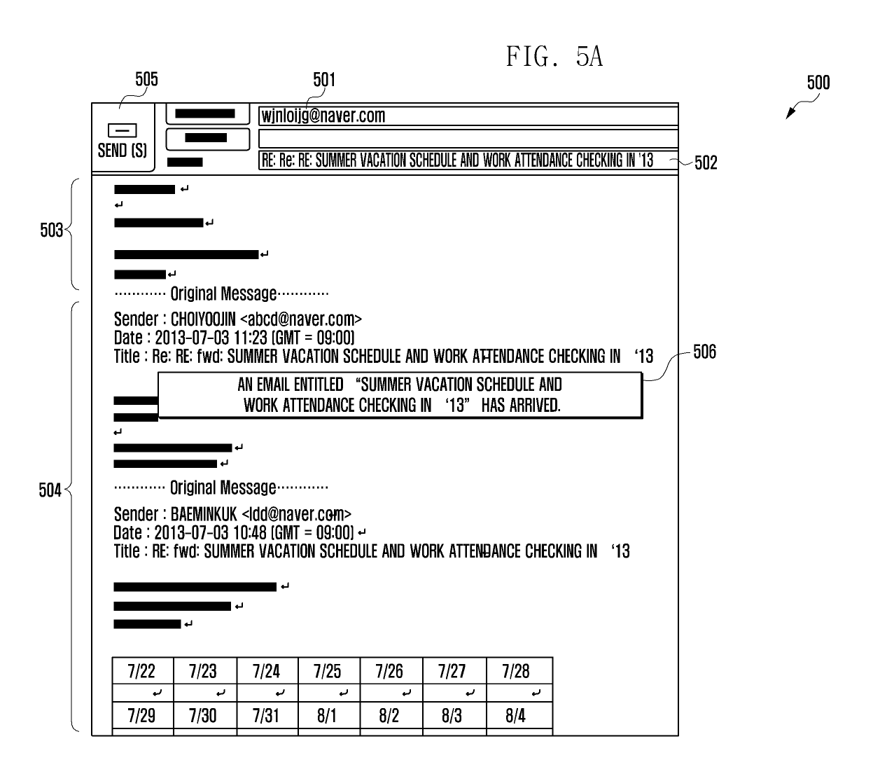

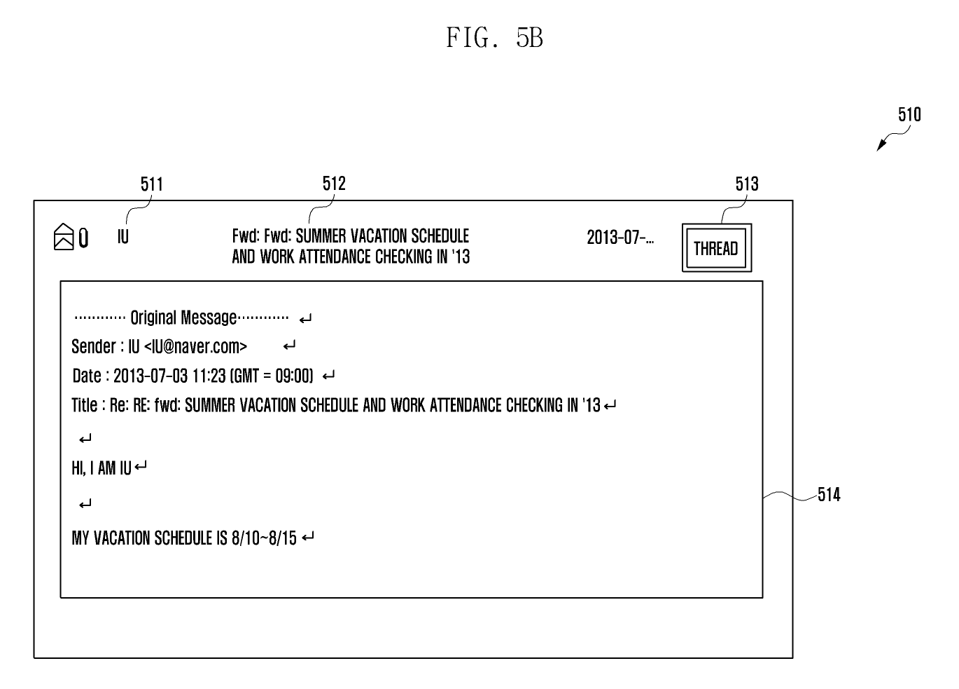

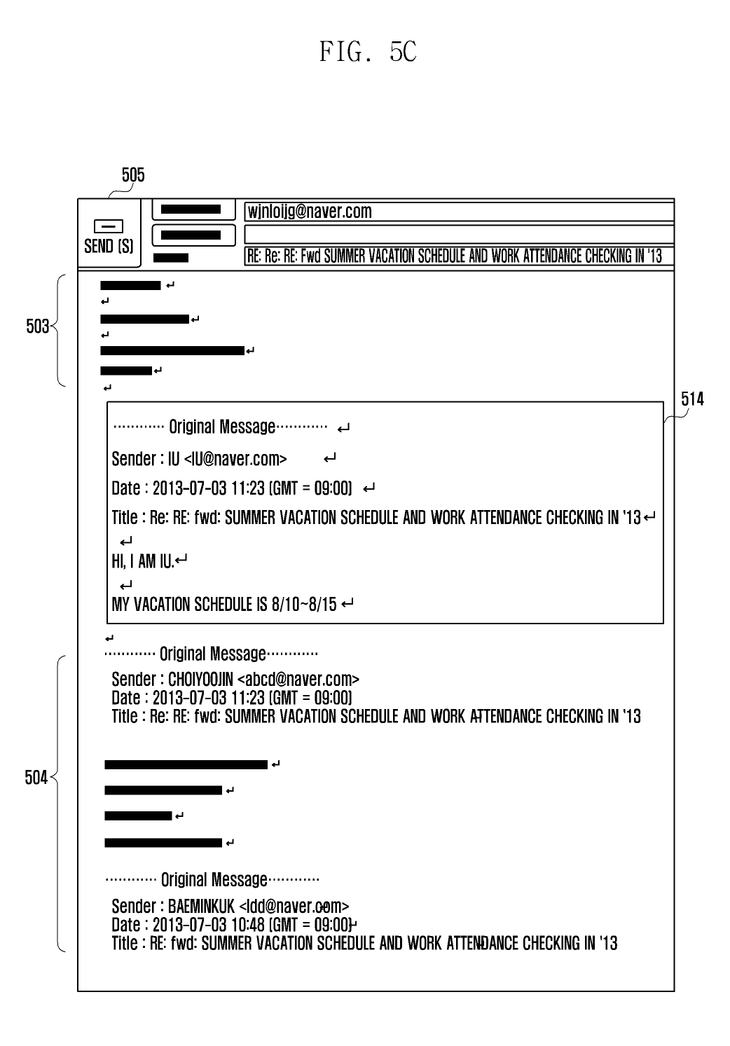

FIGS. 5A, 5B, and 5C are diagrams illustrating screen displays of an email threading procedure according to an embodiment of the present disclosure.

Referring to FIG. 5A, an email composition screen 500 of the electronic device 200 is illustrated. The processor 210 of the electronic device 200 receives replies 503 pertaining to the first email 301 transmitted by another electronic device 100 from the inbound processing server 122 (e.g., a POP server, an IMAP server, and the like). The titles of the received emails may include ‘Re:’ indicating reply 503 pertaining to the first email 301 or ‘Fwd:’ indicating the forward pertaining to the first email 301 which is followed by the title 502 of the first email 301.

For example, if the reply 503 is transmitted in response to the reply 504 entitled ‘Re: email title’ pertaining to the first email 301, the reply 503 is entitled ‘Re: Re: email title.’ In the case that multiple electronic devices receive the first email 301 and a certain recipient transmits a reply or forward pertaining to the first email 301, all of the multiple electronic devices may receive the emails generated by respective electronic devices.

The processor 124 of the mail server 120 may have to determine whether every email is the reply or forward pertaining to the first email 301.

The processor 124 of the server 120 may determine the email relationship based on whether the received email includes the content identical with that of the first email 301 as well as based on the title of the received email. This is because the user of the electronic device 100 may change the title of the reply 503 pertaining to the first email 301. Accordingly, although the reply 503 pertaining to the first email 301 is received with a different title, the processor 124 of the mail server 120 can recognize the received email as the reply 503 pertaining to the first email 301.

The processor 210 of the electronic device 200 may control the display module 241 of the display unit 240 to display the email composition screen 500 in response to the user's selection of the reply composition option. The processor 210 of the electronic device 200 may control the display module 241 to present the sender (not shown) of the first email 301 as the recipient of the reply 503 pertaining to the first email 301 in the recipient entry box 501.

The processor 210 of the electronic device 200 may control the display module 241 to present the title of the reply 503 which is entitled by adding a tag, such as ‘Re’ before the title 502 of the first email 301. The processor 210 of the electronic device 200 may control the display module 241 to display the reply composition screen 500 including the succeeding replies 504 received from other electronic devices 100 which are pertaining to the first email 301.

At this time, the processor 124 of the email server 120 may control the inbound processing server 122 (e.g., a POP server, an IMAP server, and the like) to recognize the composition of the reply 503 pertaining to the first mail 301 at the electronic device 200. The processor 124 of the email server 120 also may control the inbound processing server 122 (e.g., a POP server, an IMAP server, and the like) to determine whether any email having the same title as the first email 301 is received from another electronic device 100 in the middle of recognizing the composition of the reply 503 at the electronic device 200.

The processor 124 of the mail server 120 may control the inbound processing server 122 (e.g., a POP server, an IMAP server, and the like) to determine that there is no email having the same title 502 as the first email 301 from other electronic devices 100 while the processor 210 of the electronic device 200 is recognizing the composition of the reply 503.

In this case, if the user's selection of an email transmission button 505 (‘send’ button) is detected, the processor 210 of the electronic device 200 may control the communication unit 250 to transmit the composed reply 503 to the outbound processing server 121 (e.g., an SMTP server). The processor 124 of the email server 120 may control the inbound processing server 122 (e.g., a POP server, an IMAP server, and the like) to determine whether there is any email having the same title as the first email 301 from other electronic devices 100 while the processor 210 of the electronic device 200 is recognizing the composition of the reply 503.

In this case, if the user's selection of an email transmission button 505 (‘send’ button) is detected, the processor 210 of the electronic device 200 may control to receive a notification of the second mail pertaining to the first email 301. The processor 210 of the electronic device 200 may control the display module 241 to display an inbound mail notification popup window 506 notifying of the receipt of the second mail pertaining to the first mail 301 from the inbound processing server 122 (e.g., a POP server, an IMAP server, and the like).

Referring to FIG. 5B, if a user's selection of the inbound mail notification popup window 506 is detected, the processor 210 of the electronic device 200 may control the display module 241 to display a second mail window 510. The second mail window 510 may include a sender 511 of the second email 302, a title 512 of the second email 302, a ‘thread’ button 513, and a content 514 of the second email 302. The processor 210 of the electronic device 200 may review the content 514 of the second email 302 pertaining to the first email 301 and determine whether to thread. If a user's selection of the ‘thread’ button 513 is not detected, the processor 210 of the electronic device 200 controls the communication unit 250 to transmit the reply 503 to the outbound processing server 121 (e.g., an SMTP server) without threading the content 514 of the second email 302 pertaining to the first email 301.

Referring to FIG. 5C, if the user's selection of the ‘thread’ button is detected on the screen of FIG. 5B, the processor 210 of the electronic device 200 inserts the content 514 of the second email 302 below the content of the reply 503 being composed. At this time, the processor 210 of the electronic device 200 may arrange the second mail 302 in a chronological order. The insert position of the email content may be adjusted according to the user's intention. If the user's selection of the ‘send’ button 505 after threading the emails is detected, the processor 210 of the electronic device 200 may control the communication unit 250 to transmit the threaded mail 304 to the outbound processing server 121 (e.g., an SMTP server).

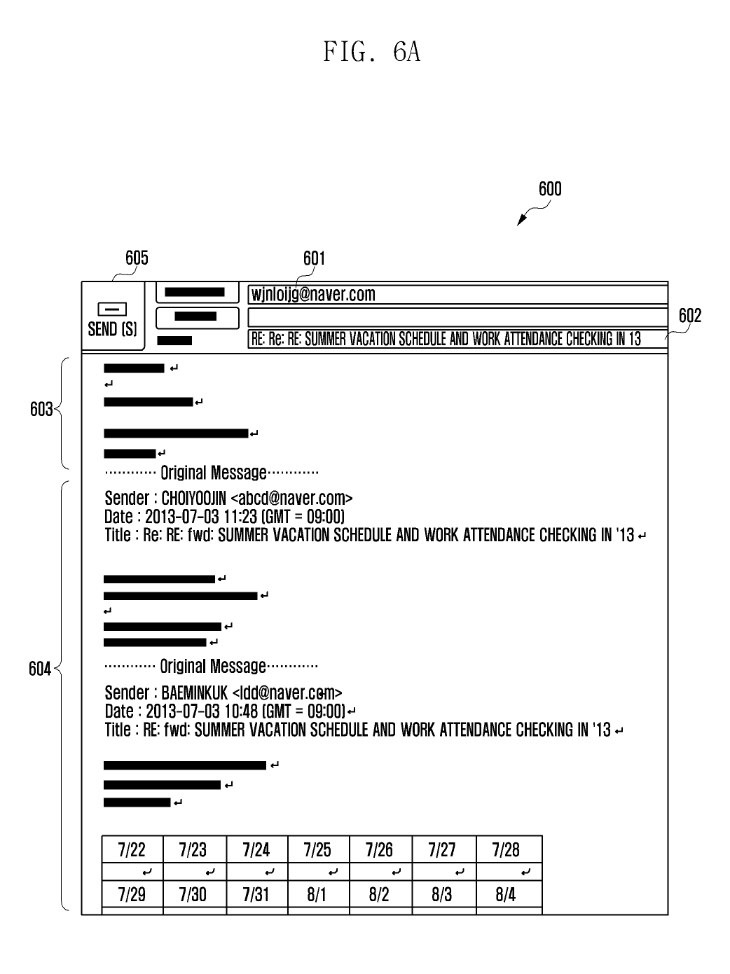

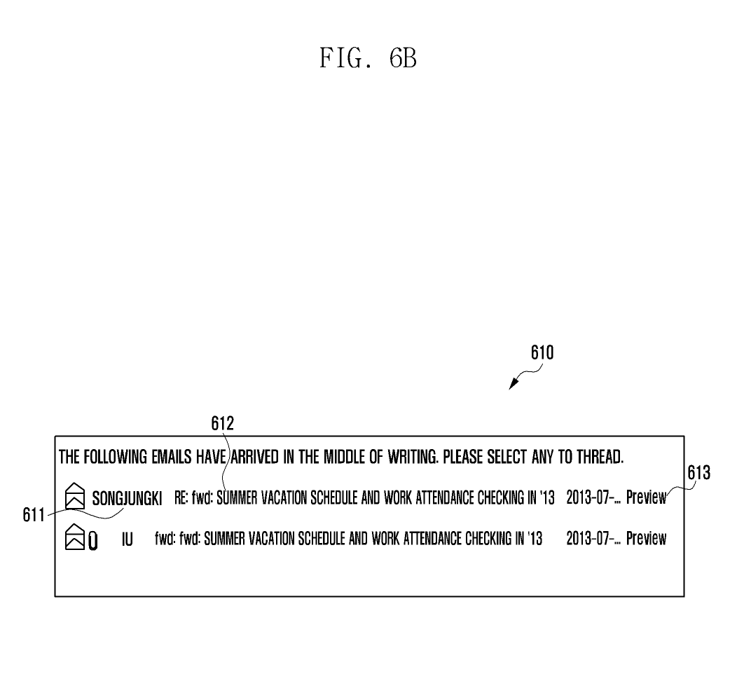

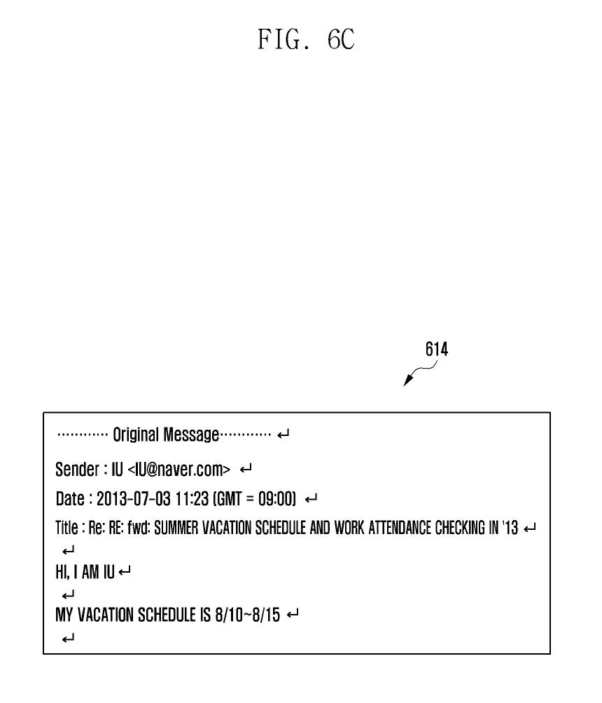

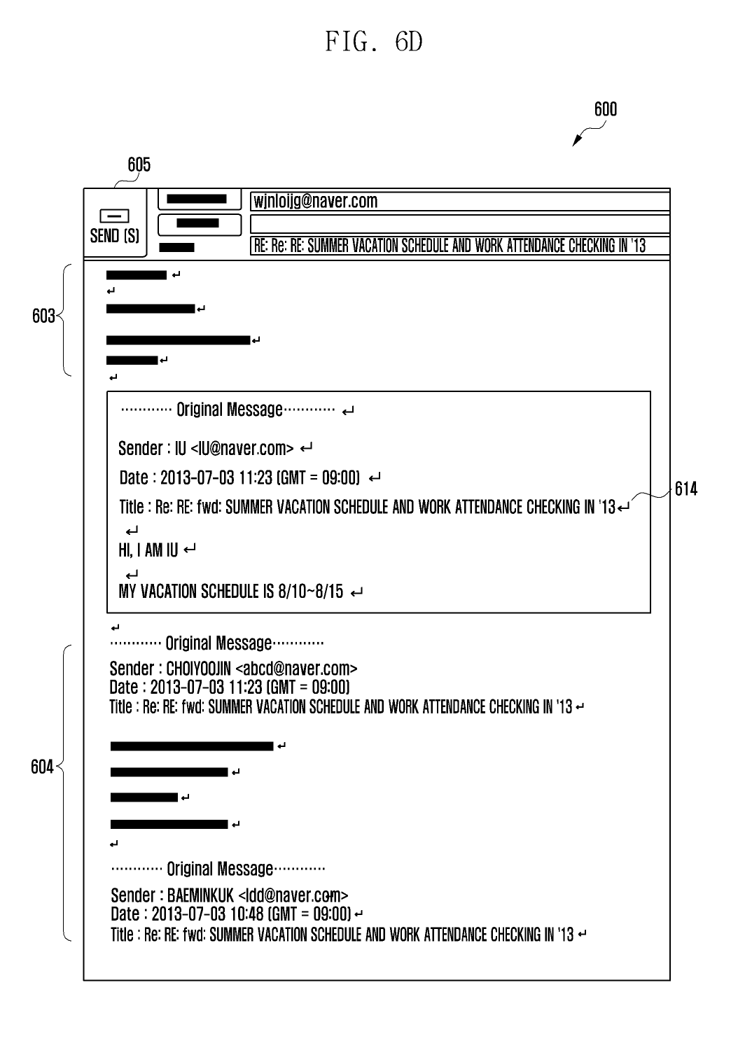

FIGS. 6A, 6B, 6C, and 6D are diagrams illustrating screen displays of an email threading procedure according to an embodiment of the present disclosure.

Referring to FIG. 6A, the processor 210 of the electronic device 200 may control the display module 241 of the display unit 240 to display an email composition screen 600 in response to the user's selection of composing a reply 603. The processor 210 of the electronic device 200 may control the display module 241 to present the sender of the first email 301 as a recipient 601 of the reply 603. The processor 210 of the electronic device 200 may control the display module 241 to present the title of the reply 603 which is entitled by adding a tag, such as ‘Re:’ before a title 602 of the first email 301. The processor 210 of the electronic device 200 may control the display module 241 to display the reply composition screen 600 including the succeeding replies 604 received from other electronic devices 100 which are pertaining to the first email 301.

At this time, the processor 124 of the email server 120 may control the inbound processing server 122 (e.g., a POP server, an IMAP server, and the like) to recognize the composition of the reply 603 pertaining to the first mail 301 at the electronic device 200. The processor 124 of the email server 120 also may control the inbound processing server 122 (e.g., a POP server, an IMAP server, and the like) to determine whether any email pertaining to the first email 301 is received from another electronic device 100 in the middle of recognizing the composition of the reply 603 at the electronic device 200.

The processor 124 of the mail server 120 may control the inbound processing server 122 (e.g., a POP server, an IMAP server, and the like) to determine that there is no email having the same title 602 as the first email 301 from other electronic devices 100 while the processor 210 of the electronic device 200 is recognizing the composition of the reply 603. In this case, if the user's selection of an email transmission button 605 (‘send’ button) is detected, the processor 210 of the electronic device 200 may control the communication unit 250 to transmit the composed reply 603 to the outbound processing server 121 (e.g., an SMTP server).

The processor 124 of the email server 120 may control the inbound processing server 122 (e.g., a POP server, an IMAP server, and the like) to determine whether there is any email having the same title as the first email 301 from other electronic devices 100 while the processor 210 of the electronic device 200 is recognizing the composition of the reply 603. In this case, if the user's selection of an email transmission button 605 (‘send’ button) is detected, the processor 210 of the electronic device 200 may control to receive a notification of the second mail 302 pertaining to the first email 301. The processor 210 of the electronic device 200 may control the display module 241 to display a second mail list 610 including the second mail pertaining to the first email 301 received from the inbound processing server 122 (e.g., a POP server, an IMAP server, and the like).

Referring to FIGS. 6B and 6D, the second mail list 610 may include a sender 611 of the second email 302, a title 612 of the second email 302, and a ‘preview’ button 613. The processor 210 of the electronic device 200 may detect the user's selection of the ‘preview’ button 613. Referring to FIG. 6C, if the user's selection of the ‘preview’ button 613 is detected, the processor 210 of the electronic device 200 may control the display module 241 to display a second mail preview window 614. The processor 210 of the electronic device 200 may detect the user's selection of the mail to be threaded after the second mail preview window 614 is closed.

Referring to FIG. 6C, if the user's selection of the second mail 302 to be threaded is detected on the screen of the FIG. 6B, the processor 210 of the electronic device 200 merges the content of the selected second email 302 with the content of the reply 603 being composed.

The processor 210 of the electronic device 200 may select multiple second emails 302 to be threaded. If a user's selection of the ‘send’ button 505 is detected after threading the emails into a threaded email, the processor 210 of the electronic device 200 controls the communication unit 250 to transmit the threaded mail to the outbound processing server 121 (e.g., an SMTP server).

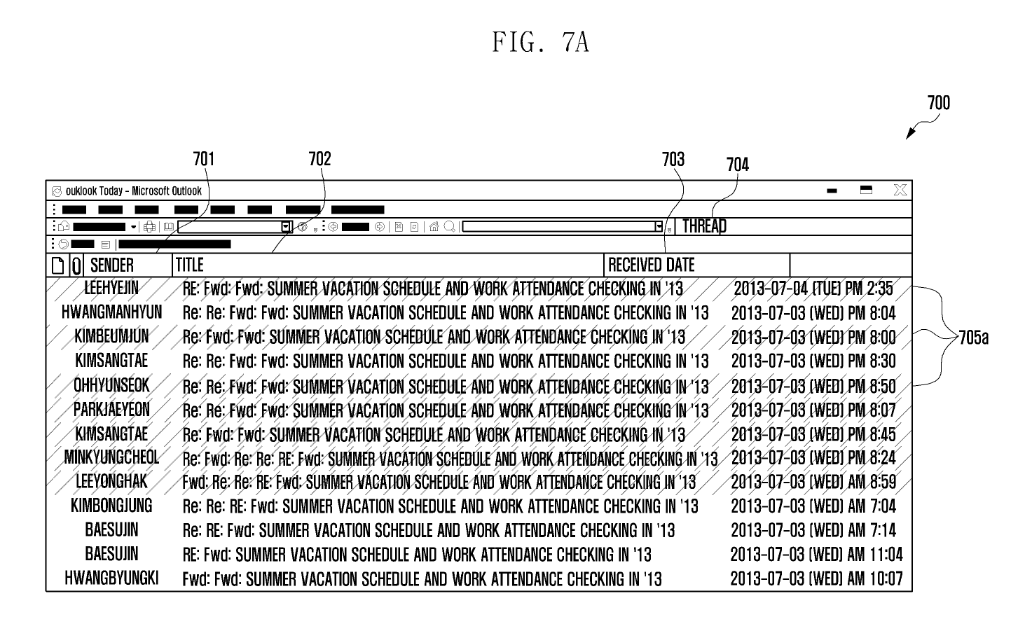

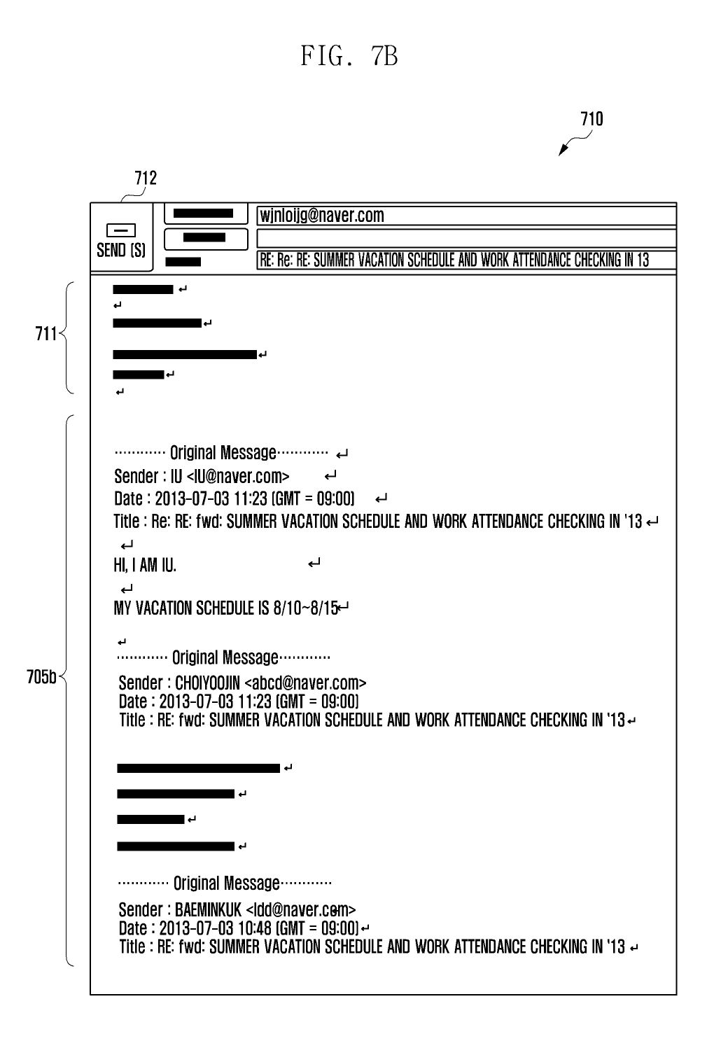

FIGS. 7A and 7B are diagrams illustrating screen displays of an email treading procedure according to an embodiment of the present disclosure.

Referring to FIG. 7A, an inbound email list 700 may include the columns (i.e., a sender 701, a title 720, and a received date 703) and a ‘thread’ button 704. The processor 210 of the electronic device 200 may control the communication unit 250 to receive the emails managed by the inbound processing server 122 (e.g., a POP server, an IMAP server, and the like). The emails may include the first email 301 and the second email 302. The processor 210 of the electronic device 200 may detect the user's selection of at least one second email 705a. If the user's selection of the ‘thread’ button 704 is detected, the processor 210 of the electronic device 200 may thread the selected second emails 705a. The user may thread the succeeding emails into a threaded email (not shown) without determining the content of the emails.

Referring to FIG. 7B, the processor 210 of the electronic device 200 may control the display module 241 to display an email composition window 710 including the succeeding replies 705b received from other electronic devices 100 which are pertaining to the first email 301. The processor 210 of the electronic device 200 may control the input unit 220 to receive the user input for composing a reply 711 in the email composition window 710. If the user's selection of a ‘send’ button 712 is detected, the processor 210 of the electronic device 200 may control the communication unit 250 to transmit the threaded email 304 to the outbound processing server 121 (e.g., an SMTP server).

According to various embodiments of the present disclosure, when the processor 210 of the electronic device 200 transmits an email, the recipient may generate the threaded email 304. The threaded email 304 may be generated according to the data configured by the processor 210 of the electronic device 200.

According to various embodiments of the present disclosure, the email threading method of an electronic device includes executing an email application, receiving a first email while the application is running, recognizing the arrival of the second email pertaining to the first email at the mail server, determining the second email if necessary, displaying the second email, threading the second email and the email being composed into a threaded email, and transmitting the threaded email to the mail server.

As described above, the electronic device of the present disclosure is advantageous in terms of improving user convenience in such a way of transmitting an email containing all of the contents of related emails so as to maintain the email thread from start to end and to allow the user to keep track of past conversations.

In the present disclosure, the terminology ‘˜module’ refers to a ‘unit’ including hardware, software, firmware or a combination thereof. For example, the terminology ‘˜module’ is interchangeable with ‘˜unit,’ ‘˜logic,’ ‘˜logical block,’ ‘˜component,’ ‘˜circuit,’ and the like. A ‘module’ may be the least unit or a part of an integrated component. A ‘module’ may be the least unit or a part thereof that can perform one or more functions. A ‘module’ may be implemented in mechanical or electronic mode. For example, ‘modules’ according to the various embodiments of the present disclosure may be implemented with at least one of the following: an application specific integrated circuit (ASIC) chip, field-programmable gate array (FPGAs) and a programmable-logic device that can perform functions that are known or will be developed.

At least part of the method (e.g., operations) or system (e.g., modules or functions) according to the various embodiments of the present disclosure can be implemented with instructions as programming modules that are stored in computer-readable storage media. One or more processors (e.g., a processor) can execute instructions, thereby performing the functions. An example of the computer-readable storage media may be memory. At least part of the programming modules can be implemented (executed) by processor. At least part of the programming module may include modules, programs, routines, sets of instructions or processes, and the like, in order to perform one or more functions.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

Modules or programming modules according to the various embodiments of the present disclosure may include one or more components, remove part of them described above, or include new components. The operations performed by modules, programming modules, or the other components, according to the present disclosure, may be executed in serial, parallel, repetitive or heuristic fashion. Part of the operations can be executed in any other order, skipped, or executed with additional operations.

While the present disclosure been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An email threading method of an electronic device, the method comprising:
executing an email application;
receiving a first email based on the email application;
determining arrival of a second email pertaining to the first email at an email server;
displaying, when a request is detected, the second email;
threading the second email and an email being composed; and
transmitting the threaded email to a mail server.

2. The method of claim 1, wherein the displaying of the second email comprises presenting the second email in a form of one of a button, a popup window, and a list.

3. The method of claim 1, wherein the determining of the arrival of the second email comprises determining the arrival of the second email in one of composing a reply pertaining to the first email and transmitting the reply.

4. The method of claim 3, wherein the determining of the arrival of the second email comprises receiving an inbound mail notification from the mail server.

5. The method of claim 1, further comprising determining whether an email pertaining to the first email has been received at the mail server.

6. The method of claim 1, wherein the threading of the second email and the email being composed comprises determining the content of the second email.

7. The method of claim 1, wherein the treading of the second email and the email being composed comprises selecting a plurality of the second emails to be threaded.

8. The method of claim 1, wherein the threading of the second email and the email being composed is performed by a recipient of the email pertaining to the first email.

9. The method of claim 1, wherein the threading of the second email and the email being composed comprises arranging the first and second emails in chronological order of composition time.

10. The method of claim 1, wherein the threading of the second email and the email being composed comprises adjusting a position of the second email in the threaded email.

11. An electronic device comprising:
a display unit having a display module configured to display an email composition window and a list;
an input unit having at least one of a touch panel, a pen sensor, and a microphone configured to recognize composition of an email;
a memory configured to store an email application providing the email composition window; and
a processor configured to control a communication unit configured to communicate between the electronic device and an email server,
wherein the processor is further configured:
to execute the email application,
to receive a first email based on the email application,
to determine arrival of a second email pertaining to the first email at an email server,
to display, when a request is detected, the second email,
to thread the second email and an email being composed, and
to transmit the threaded email to the mail server.

12. The electronic device of claim 11, wherein the processor is further configured present the second email in a form of one of a button, a popup window, and a list.

13. The electronic device of claim 11, wherein the processor is further configured:
to determine the arrival of the second email in one of composing a reply pertaining to the first email, and
to transmit the reply.

14. The electronic device of claim 11, wherein the processor is further configured to receive an inbound mail notification from the mail server.

15. The electronic device of claim 11, wherein the processor is further configured to determine whether an email pertaining to the first email has been received at the mail server.

16. The electronic device of claim 11, wherein the processor is further configured to thread the second email and the email being composed after determining the content of the second email.

17. The electronic device of claim 11, wherein the second email and the email being composed are threaded by a recipient of the email pertaining to the first email.

18. The electronic device of claim 11, wherein the processor is further configured to thread the first and second emails in chronological order of composition time.

19. The electronic device of claim 11, wherein the processor is further configured to adjust a position of the second email in the threaded email.

20. A non-transitory computer readable storage medium for storing an email threading program, the email threading program comprising:
executing an email application;
receiving a first email based on the email application;
determining arrival of a second email pertaining to the first email at an email server;
displaying, when a request is detected, the second email;
threading the second email and an email being composed; and
transmitting the threaded email to a mail server.
